(19) United States
(12) Patent Application Publication
(10) Pub. No.: US 2016/0104558 A1
(43) Pub. Date: Apr. 14, 2016

(54) METHOD OF MANUFACTURING TOUCH DEVICE WITH CURVED TOUCH SURFACE ON SUBSTRATE

(71) Applicant: HON HAI PRECISION INDUSTRY CO., LTD., New Taipei (TW)

(72) Inventor: HSIN-HUA CHANG, New Taipei (TW)

(21) Appl. No.: 14/550,355

(22) Filed: Nov. 21, 2014

(30) Foreign Application Priority Data
Oct. 14, 2014 (TW) 103135585

(51) Int. Cl. H01B 13/00

(52) U.S. Cl. CPC H01B 13/0026; H01B 13/003

(57) ABSTRACT

A method of manufacturing a touch device is provided. The method includes: providing a transparent substrate, the transparent substrate being curved and including a touch surface and a connecting surface; coating a conductive material layer on the connecting surface; coating a photo-resist material layer on the conductive material layer; providing a mask, the mask being curved and made of transparent material; coating a pattern of circuit on the mask, the pattern of circuit made of opaque material; placing the mask with the pattern of circuit on the photo-resist material layer, the pattern of circuit touching the photo-resist material layer and totally covered by the photo-resist material layer; photo-etching the conductive material layer to form a conductive circuit layer on the connecting surface; and connecting a drive circuit to the conductive circuit layer to obtain the touch device.

### FIELD

The subject matter herein generally relates to touch devices, and particularly to a method of manufacturing a touch device having a curved touch surface.

### BACKGROUND

Nowadays, touch devices are applied to flat display devices, for example, tablet computer, such that users can operate the flat display devices by touching the touch devices.

### BRIEF DESCRIPTION OF THE DRAWINGS

Implementations of the present technology will now be described, by way of example only, with reference to the attached figures.

FIG. 1 is a flowchart illustrating an embodiment of a method of manufacturing a touch device.

FIG. 2 is a diagrammatic view illustrating a stage of the method of FIG. 1, wherein a conductive material layer is coated on a transparent substrate.

FIG. 3 is a diagrammatic view illustrating a stage of the method of FIG. 1, wherein a photo-resist material layer is coated on the conductive material layer.

FIG. 4 is a diagrammatic view illustrating a stage of the method of FIG. 1, wherein a pattern of circuit is positioned on a mask.

FIG. 5 is a diagrammatic view illustrating a stage of the method of FIG. 1, wherein the mask with the pattern of circuit is positioned on the photo-resist material layer.

FIG. 6 is a diagrammatic view illustrating a stage of the method of FIG. 1, wherein the conductive material layer is photo-etched to form a conductive circuit layer and a drive circuit is connected to the conductive circuit layer to obtain the touch device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

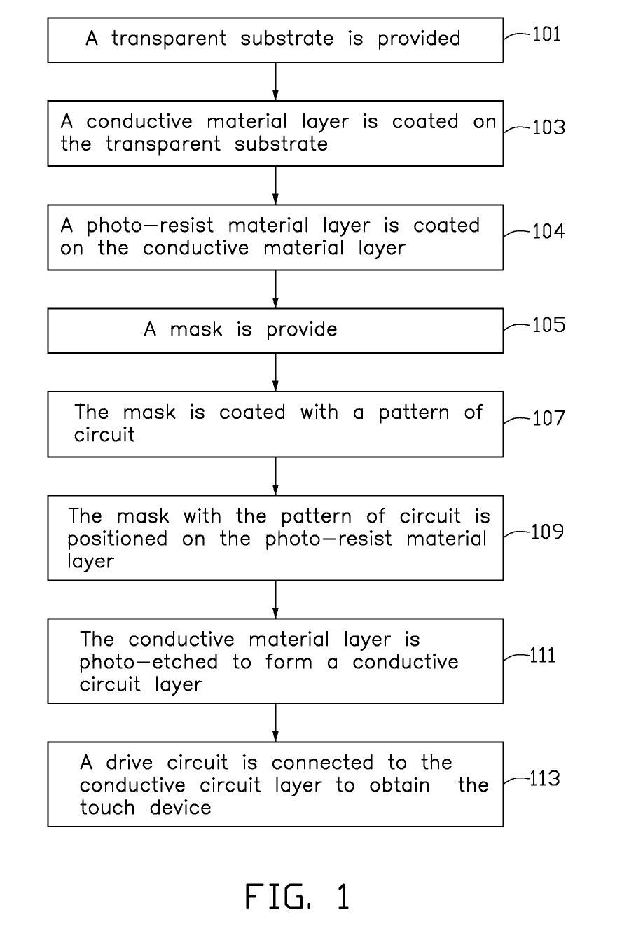

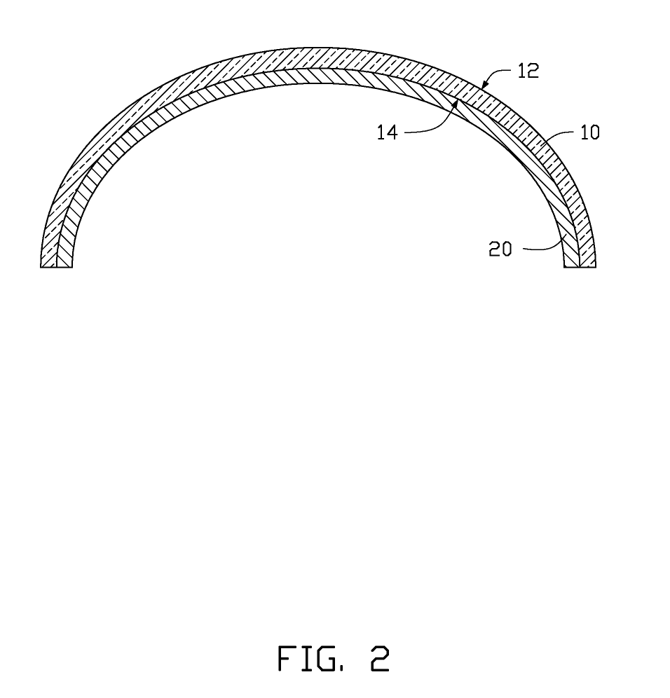

Referring to FIG. 1, a flowchart is presented in accordance with an example embodiment. An example method is provided by way of example, as there are a variety of ways to carry out the method. The example method described below can be carried out using the configurations illustrated in FIGS. 2-6, for example, and various elements of these figures are referenced in explaining example method. Each block shown in FIG. 1 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 101.

At block 101, a transparent substrate is provided.

Referring to FIG. 2, a transparent substrate 10 is provided. The transparent substrate 10 is curved and includes a touch surface 12 and a connecting surface 14. The touch surface 12 and the connecting surface 14 are positioned at two sides of the transparent substrate 10 and are opposite to each other. The touch surface 12 is convex and the connecting surface 14 is concave. The transparent substrate 10 can be made of glass material or polymethyl methacrylate.

At block 103, a conductive material layer is coated on the transparent substrate.

A conductive material layer 20 is evenly coated on the connecting surface 14. The conductive material layer 20 is also curved and totally coated on the connecting surface 14. The conductive material layer 20 can be made of indium tin oxide (ITO).

At block 104, a photo-resist material layer is coated on the conductive material layer.

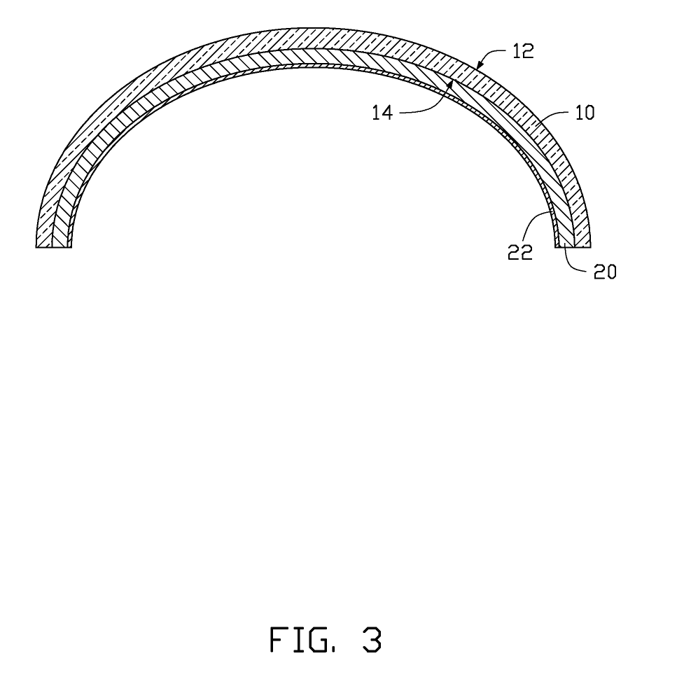

Referring to FIG. 3, a photo-resist material layer 22 is coated on the conductive material layer 20. In the illustrated embodiment, the photo-resist material layer 22 is made of positive photo-resist material.

At block 105, a mask is provide.

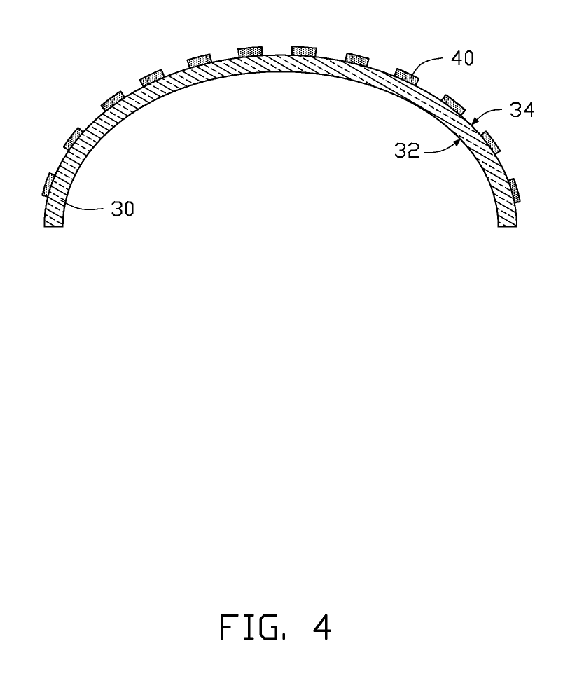

Referring to FIG. 4, a mask 30 is provided. The mask 30 is curved and made of transparent material. The transparent material can be glass material, sapphire, or polymethyl methacrylate. The mask 30 includes a light incident surface 32 and a light emergent surface 34. The light incident surface 32 and the light emergent surface 34 are positioned at two sides of the mask 30 and opposite to each other. The light incident surface 32 is concave and the light emergent surface 34 is convex.

At block 107, the mask is coated with a pattern of circuit.

The light emergent surface 34 is coated with a pattern of circuit 40. The pattern of circuit 40 is made of opaque material. In the illustrated embodiment, the pattern of circuit 40 is projecting from the light emergent surface 34 and made of opaque rubber material.

At block 109, the mask with the pattern of circuit is positioned on the photo-resist material layer.

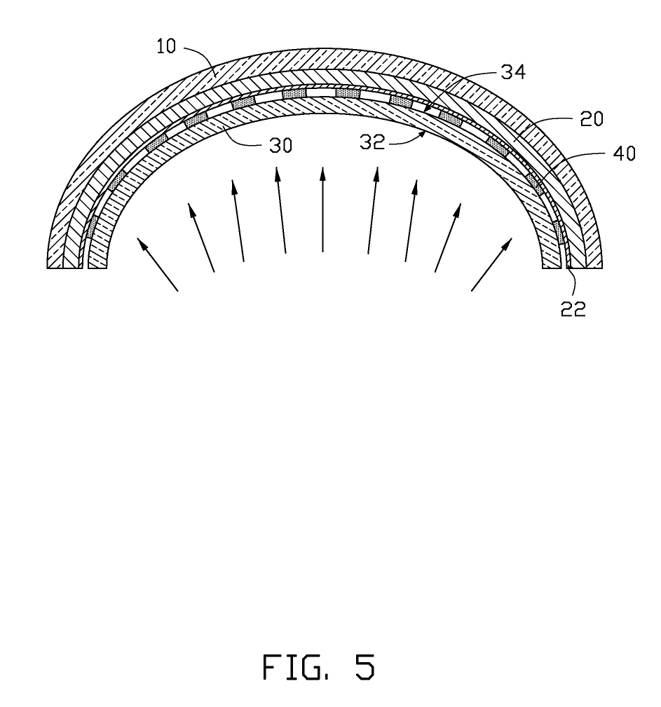

Referring to FIG. 5, the mask 30 with the pattern of circuit 40 is positioned on the photo-resist material layer 22, with the pattern of circuit 40 touching the photo-resist material layer 22 and totally covered by the photo-resist material layer 22. The pattern of circuit 40 separates the photo-resist material layer 22 from the mask 30.

At block 111, the conductive material layer is photo-etched to form a conductive circuit layer.

The transparent substrate 10 and the mask 30 are positioned in a vacuum room and then a light is applied to irradiate the mask 30. The light enters the mask 30 from the light incident surface 32 and emits from the light emergent surface 34. The pattern of circuit 40 barriers a portion of the light and the remainder of the light transmits through to irradiate the photo-resist material layer 22. A portion of the photo-resist material layer 22 without covered by the pattern of circuit 40 is exposed with the light. In the illustrated embodiment, the light can be UV light or yellow light.

The mask 30 is taken apart from the transparent substrate 10. The transparent substrate 10 with the conductive material layer 20 and the photo-resist material layer 22 is positioned in developer solution and the exposed portion of the photo-resist material layer 22 is washed away.

Etching liquid is applied to remove a portion of the conductive material layer 20 which is not covered by the remainder photo-resist material layer 22. Finally, the remainder photo-resist material layer 22 is removed and then a conductive circuit layer 50 is formed on the connecting surface 14. The conductive circuit layer 50 has the same pattern as the pattern of circuit 40.

At block 113, a drive circuit is connected to the conductive circuit layer to obtain the touch device.

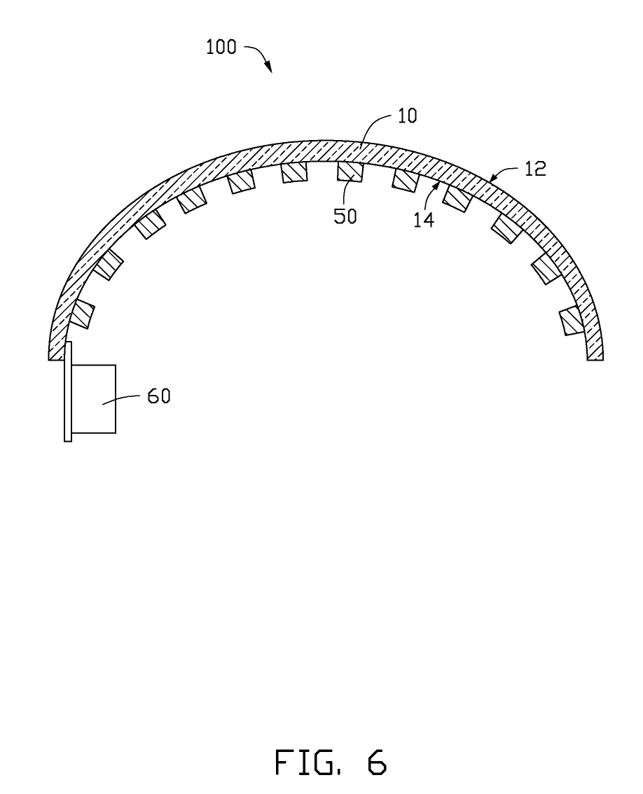

Referring to FIG. 6, a drive circuit 60 is connected to the conductive circuit layer 50 to obtain the touch device 100. The touch device 100 includes the transparent substrate 10, the conductive circuit layer 50, and the drive circuit 60. When the touch surface 12 is touched, the transparent substrate 10 would generate an elastic deformation. The conductive circuit layer 50 detects the elastic deformation to generate a touch signal. The touch signal is transmitted to the drive circuit 60.

The touch device 100 includes a drive electrode and a current receiving electrode. The drive electrode emits a signal of low voltage and high frequency through the conductive circuit layer 50 to the current receiving electrode. Since human body has electrical field, a coupling capacity is generated between a finger of a user and the touch surface 12 when the touch surface 12 is touched by the finger. The coupling capacity can conduct a high frequency current. When the touch surface 12 is touched by the finger, a portion of the high frequency current is absorbed in the coupling capacity. The closer the finger to the drive electrode, the high frequency current is absorbed more by the coupling capacity. The touch device 100 detects the position where the touch surface 12 is touched according to the intensity of the high frequency current received by the current receiving electrode.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A method of manufacturing a touch device, comprising:
providing a transparent substrate, the transparent substrate being curved and comprising a touch surface and a connecting surface, the touch surface being convex, and the connecting surface being concave;
coating a conductive material layer on the transparent substrate, the conductive material layer being curved and totally coated on the connecting surface;
coating a photo-resist material layer on the conductive material layer;
providing a mask, the mask being curved and made of transparent material, the mask comprising a light incident surface and a light emergent surface, the light incident surface and the light emergent surface being positioned at two sides of the mask and opposite to each other, the light incident surface being concave, and the light emergent surface being convex;
coating a pattern of circuit on the mask, the pattern of circuit made of opaque material;
placing the mask with the pattern of circuit on the photo-resist material layer, the pattern of circuit touching the photo-resist material layer and totally covered by the photo-resist material layer;
photo-etching the conductive material layer to form a conductive circuit layer on the connecting surface; and
connecting a drive circuit to the conductive circuit layer to obtain the touch device.

2. The method of claim 1, wherein the transparent substrate is made of glass material or polymethyl methacrylate.

3. The method of claim 1, wherein the conductive material layer is made of indium tin oxide.

4. The method of claim 1, wherein the photo-resist material layer is made of positive photo-resist material.

5. The method of claim 1, wherein the mask is made of a material selected from a group consisting of glass material, sapphire, and polymethyl methacrylate.

6. The method of claim 1, wherein the pattern of circuit is projecting from the light emergent surface.

7. The method of claim 1, wherein photo-etching the conductive material layer to form a conductive circuit layer on the connecting surface comprises:
positioning the transparent substrate, the conductive material layer, the photo-resist material layer, the mask, and the pattern of circuit in a vacuum room;
applying light to irradiate the mask, with the light entering the mask from the light incident surface and emitting from the light emergent surface and the pattern of circuit barring a portion of the light and the remainder of the light transmitting through to irradiate the photo-resist material layer;
taking the mask apart from the transparent substrate;
positioning the transparent substrate with the conductive material layer and the photo-resist material layer in developer solution;
washing away a portion of the photo-resist material layer which is exposed with the light;
applying etching liquid to remove a portion of the conductive material layer which is not covered by the remainder photo-resist material layer; and
removing the remainder photo-resist material layer to obtain the conductive circuit layer on the connecting surface, with the conductive circuit layer having the same pattern as the pattern of circuit.

8. A method of manufacturing a curved touch screen comprising:
providing an arcuate transparent substrate strip, the substrate having an outer convex touch surface and an inner concave connecting surface opposite the outer convex touch surface;
coating the concave connecting surface of the transparent substrate strip with a layer of conductive material;
coating the conductive material layer with a layer of photo-resist material;
coating, with opaque material, a pattern of a circuit on an arcuate mask made of transparent material, the arcuate mask having a concave light incident surface and an opposite convex light emergent surface, the coating being made on the convex surface of the mask;
placing the mask against the photo-resist layer with the pattern of the coating completely disposed against the photo-resist layer;
photo-etching the conductive layer into the pattern of the coating of the opaque material on the mask to form a conductive circuit on the connecting surface of the substrate; and
connecting a drive circuit to the conductive circuit forming a touch device.

9. A method of manufacturing a curved touch screen comprising:
providing an arcuate transparent substrate strip having a first strip end and a second strip end, the substrate curved with the first strip end positioned toward the second strip end and having an outer convex touch surface extending between the first strip end and the second strip end and an inner concave connecting surface opposite the outer convex touch surface extending between the first strip end and the second strip end;
coating the concave connecting surface of the transparent substrate strip with a layer of conductive material;
coating the conductive material layer with a layer of photo-resist material;
coating, with opaque material, a pattern of a circuit on an arcuate mask made of transparent material, the arcuate mask having a concave light incident surface and an opposite convex light emergent surface, the coating being made on the convex surface of the mask;
placing the mask against the photo-resist layer with the pattern of the coating completely disposed against the photo-resist layer;
photo-etching the conductive layer into the pattern of the coating of the opaque material on the mask to form a conductive circuit on the connecting surface of the substrate; and
connecting a drive circuit to the conductive circuit forming a touch device.
